(19) United States
(12) Patent Application Publication
(10) Pub. No.: US 2025/0197222 A1
(43) Pub. Date: Jun. 19, 2025

(54) ACCORDION-SHAPED LIGNIN CUBIC CARBON MATERIAL, AND PREPARATION THEREFOR AND APPLICATION THEREOF IN SUPERCAPACITOR

(71) Applicants: SOUTH CHINA UNIVERSITY OF TECHNOLOGY, Guangzhou City, Guangdong Province (CN); GUANGDONG UNIVERSITY OF TECHNOLOGY, Guangzhou City, Guangdong Province (CN)

(72) Inventors: Xueqing QIU, Guangzhou (CN); Dongjie YANG, Guangzhou (CN); Fangbao FU, Guangzhou (CN); Conghua YI, Guangzhou (CN); Wenli ZHANG, Guangzhou (CN); Hongming LOU, Guangzhou (CN); Jinhao HUANG, Guangzhou (CN); Yuxia PANG, Guangzhou (CN); Weifeng LIU, Guangzhou (CN); Yanlin QIN, Guangzhou (CN)

(73) Assignees: SOUTH CHINA UNIVERSITY OF TECHNOLOGY, Guangzhou City, Guangdong Province (CN); GUANGDONG UNIVERSITY OF TECHNOLOGY, Guangzhou City, Guangdong Province (CN)

(21) Appl. No.: 18/549,935

(22) PCT Filed: Oct. 10, 2022
(86) PCT No.: PCT/CN2022/124434

§ 371 Date: Jan. 16, 2025

(30) Foreign Application Priority Data
Feb. 22, 2022 (CN) 202210163985.4

(51) Int. Cl. C01B 32/05; H01G 11/44

(52) U.S. Cl. CPC C01B 32/05; C01P 2004/03; C01P 2004/04; C01P 2006/12; C01P 2006/14; C01P 2006/40; H01G 11/44

(57) ABSTRACT

The present invention discloses an accordion-shaped lignin cubic carbon material, a preparation thereof, and an application thereof in a supercapacitor. The preparation method comprises the following steps: firstly, dissolving industrial lignin in an alkali solution and purifying in a weak acid solution; then forming, with a block copolymer, a mixed micelle of the lignin/the block copolymer in a mixed solvent of alcohol and water, then sequentially adding a soluble zinc salt and a soluble oxalate, and carrying out solvent evaporating induction under a neutral condition to co-deposit the mixed micelle and zinc oxalate, with an evaporation rate at the same time, to deposit the mixed micelle of lignin/block copolymer between zinc oxalate layers, to construct a cubic lignin/block copolymer/zinc oxalate complex with ordered structure; and after finally carbonizing, obtaining an accordion-shaped lignin cubic carbon material. This material has a rich ion migration space and is internally provided with interconnected supporting nanosheet layers so that the problem that carbon nanosheets are easy to accumulate is solved, the effective surface utilization rate is improved, and performances of the mass, the area-specific capacitance and the rate capability of a supercapacitor are remarkably improved.

### TECHNICAL FIELD

The present invention belongs to a technical field of a biomass carbon material, specifically relates an accordion-shaped lignin cubic carbon material, a preparation method therefor and an application thereof in supercapacitor.

### BACKGROUND

As a new type of energy storage device, supercapacitors have the advantages of high power density, fast charge and discharge, long cycle life, and wide applicable temperature range, and are widely used in fields such as power grid frequency regulation and backup power supply. Electrode materials are the key factors affecting the performance of supercapacitors. Carbon materials have the advantages of wide sources, adjustable pore structure, good conductivity, etc., and are widely used electrode materials now. Activated carbon has a high specific surface area, low cost, and stable chemical properties, however, its mass-specific capacitance is lower due to structural disorder. The theoretical specific capacity of graphene is 550 F/g, however, its carbon nanosheets are easy to accumulate, resulting in low utilization of effective specific surface area, significantly reducing area-specific capacity. Moreover, the high cost of the graphene is not conducive to industrial application. Therefore, there is an urgent need to develop a carbon material for supercapacitors with wide sources, low cost, high mass-specific capacitance and area-specific capacitance, and industrial potential.

Lignin is a plant resource being the second largest in reserves, accounting for about 30% of the dry weight of the plant. It has a structural unit of phenylpropane, contains a large number of benzene ring structures and oxygen-containing functional groups with carbon content up to 60%, and is an ideal precursor of carbon material. It can be converted into functional carbon material by pyrolysis, and its use as an energy storage electrode material has become a research hotspot in recent years.

The microstructure characteristic of a lignin carbon material is the key factors affecting the performance of supercapacitors. An orderly hierarchical porous structure can improve the effective surface utilization of carbon material, thereby improving capacitive performance. Two-dimensional carbon nanosheets have open active sites and good structural continuity, which can accelerate ion transport and electron transport. Therefore, two-dimensional carbon nanosheets have received widespread attention. Chinese patent application CN109485029A disclosed a preparation of porous carbon nanosheets using lignin and its application in supercapacitors. In the method, a water-soluble sulfonated lignin was used as a carbon precursor and dispersant, and a weakly corrosive oxalate was used as an activator. It comprised the following steps: dissolving the water-soluble sulfonated lignin and the oxalate in an aqueous solvent, adding ethanol dropwise for multiple hydrophobic self-assembly to prepare a lignin/oxalate complex, then carbonizing to obtain a lignin porous carbon nanosheets. A specific surface area of the carbon nanosheets reached 1069 m²/g, and the specific capacitance at a current density of 1 A/g was 320 F/g. In order to obtain the nanosheet layer structure and avoid the accumulating of nanosheets, at least 6 or more times of self-assembly process was performed in the procedure, and the operation process was cumbersome, which was difficult to produce on a large scale. In addition, the direct use of oxalate with poor water solubility resulted in the disorder of the structure of lignin carbon. Fu et al. (Chemical Engineering Journal 392 (2020) 12372) used sodium lignosulfonate as a carbon source as well as zinc oxalate generated by zinc nitrate and sodium oxalate as a template and an activator, and formed a suspension by adding sodium oxalate into a mixed aqueous solution of sodium lignosulfonate and zinc nitrate. Then, a lignin/zinc oxalate complex was prepared by adding stepwise and dropwise ethanol for hydrophobic self-assembly, which was carbonized to prepare a lignin quasi-nanosheet carbon material with two-dimensional interconnection. Compared with the lignin carbon prepared directly by zinc oxalate, the lignin carbon prepared by using the synthetic zinc oxalate as the template had a more orderly lamellar structure, but its nanosheets were seriously accumulated, resulting in a thicker lignin carbon sheet layer, which reduced the effective utilization rate of the specific surface area of the material. Liu et al. (RSC Adv., 2017, 7, 48537) prepared lignin carbon nanosheets by using alkali lignin as a raw material and ice crystals generated by freezing casting in liquid nitrogen as a template, and direct carbonizing. The specific capacitance of the carbon nanosheets prepared by this method was 281 F/g at a current density of 0.5 A/g.

The overall structure of two-dimensional carbon nanosheets obtained by the above-described preparation method was disordered, the specific surface area was higher, and there were problems such as unsupported sheet layers, poor structural stability, and low effective utilization rate of specific surface area, resulting in lower area specific capacity thereof. Therefore, in order to improve the structural stability of carbon nanosheets, the researchers prepared a carbon material with a stereostructure composed of nanosheet layers. Binpeng Zhang (B. Zhang et al./Carbon 162 (2020) 256-266) carried out a volatilization-induced self-assembly process with enzymatic hydrolysis lignin and nano-MgO of two-dimensional sheet shape to obtain a flower-shaped structural lignin/Mg(OH)₂ complex, then carbonized the complex and removed the template to obtain a lignin-based flower-shaped carbon material with a diameter of 5 μm. This material had a stable flower-shaped structure, and enhanced the photocatalytic performance of zinc oxide, compared with two-dimensional carbon nanosheets. However, the specific surface area was only 827 m²/g, and the overall structure of the flower-shaped carbon was larger, which had insufficient active sites as an electrode material and was not suitable as the electrode material. Wang et al. (F. Wang et al./Journal of Alloys and Compounds 812 (2020) 152109) synthesized flower-shaped carbon spheres with a diameter of 3 μm by direct carbonization method, through using urea-formaldehyde resin as a raw material, which had a specific surface area of 611 m²/g and a specific capacitance of 276 F/g at a scan rate of 2 mV/s. Liang et al. (J. Mater. Chem. A, 2014, 2, 16884-16891) prepared a flower-shaped carbon material with a diameter of 5 μm and a specific surface area of 796 m²/g by hydrothermal reaction and high-temperature carbonization, through using glucose as the carbon source and flower-shaped Ni (OH) 2 as the template. It had a specific capacitance of 226 F/g at a current density of 0.5 A/g, and a specific capacitance of 185 F/g at a high current density of 20 A/g, with a retention rate of specific capacitance of up to 82%. Compared with two-dimensional carbon nanosheets, the flower-shaped carbon material had better structural stability and showed good rate capability. However, the dense core of the flower-shaped structure reduced the specific surface area of the carbon nanosheets, resulting in a decrease in the active sites of the electrolyte ion, especially a lower mass-specific capacitance at a low current density.

A three-dimensional cubic carbon material has a stable frame structure and sufficient space inside to load active materials and has significant advantages as an electrode material for energy storage. For example, metal-organic framework material (such as ZIF-8, ZIF-67) derived carbon material has a three-dimensional nano cube structure, can significantly improve the solid load rate of polysulfides as an electrode material for sodium-sulfur ion battery, and effectively catalyzes redox reactions of sulfur (Small Methods 2021, 2100455). However, there are still no reports about a lignin cubic carbon material.

In summary, the lignin carbon materials prepared by the prior art or the existing processes at present have problems such as poor structural stability, the low effective utilization rate of surface area, as a result, low specific capacitance and poor rate capability. The following key problems need to be solved. First, the interaction force between the activator or template agent used in the prior art and lignin is weak, and the two cannot be effectively combined to construct a macroscopically ordered precursor, resulting in disorder in the overall structure of the lignin carbon material, which significantly reduces the mass-specific capacity and rate capability. Second, the used activator or template agent has no good confinement effect on the lignin carbon skeleton, resulting in poor structural stability and seriously accumulating of the obtained lignin carbon nanosheets, which significantly reduces the effective specific surface area and leads to a lower area-specific capacity.

### SUMMARY

In order to overcome the shortcomings and deficiencies of the prior art, a primary objective of the present invention is to provide a preparation method for an accordion-shaped lignin cubic carbon material.

The method described in the present invention is to prepare the accordion-shaped lignin cubic carbon material by an evaporation assembling and carbonization method. The method comprises the following steps: first, dissolving industrial lignin in an alkaline solution, then purifying the lignin in a weak acid solution, to enhance its solubility in an alcohol-water mixed solvent, further forming a mixed micelle of the lignin/the block copolymer in the alcohol-water mixed solvent by utilizing hydrogen-bond interaction of the purified lignin and the block copolymer, then sequentially adding a soluble zinc salt and a soluble oxalate, co-depositing the mixed micelle and zinc oxalate by carrying out solvent evaporating induction under a neutral condition, simultaneously depositing the mixed micelle of the lignin/the block copolymer between zinc oxalate layers by controlling an evaporation rate, and constructing a cubic lignin/block copolymer/zinc oxalate complex with ordered structure. After subsequently carbonizing, an accordion-shaped lignin cubic carbon material is obtained, which has an ordered structure, good stability, and internal sheet layers supported by and connected.

Another objective of the present invention is to provide an accordion-shaped lignin cubic carbon material prepared by the above-described method. The material has rich ion migration space and has interconnected supporting nanosheet layers inside so that the problem that carbon nanosheets are easy to accumulate is solved, and the effective surface utilization rate is improved, which remarkably improves the mass-specific capacitance and area-specific capacitance and rate capability of a supercapacitor.

In the present invention, the accordion-shaped lignin cubic carbon material has a specific surface area of not less than 1000 m²/g, a size of not more than 2 μm, and a thickness of the sheet layer of less than 20 nm.

Still, another objective of the present invention is to provide an application of the above-described accordion-shaped lignin cubic carbon material in a supercapacitor.

Objectives of the present invention are realized by the following technical solutions.

A preparation method for an accordion-shaped lignin cubic carbon material comprises the following steps:
(1) dissolving industrial lignin into an alkali solution with a pH of 12 or more, then adding an acid for adjusting the pH of the solution to 5 to 7, filtering to separate a precipitate, and drying the precipitate, to obtain purified lignin;
(2) adding the purified lignin and a block copolymer into a mixed solvent of ethanol and water, stirring for 2 to 4 h, standing still for 3 to 6 h, to form a mixed micelle of the lignin/the block copolymer, then sequentially adding dropwise a soluble zinc salt solution and a soluble oxalate solution, evaporating at 70 to 90° C. for 4 to 8 h, filtering, and drying, to obtain a lignin/block copolymer/zinc oxalate complex; and
(3) carbonizing the lignin/block copolymer/zinc oxalate complex, washing, centrifuging, and drying, to obtain an accordion-shaped lignin cubic carbon material.

Preferably, in the step (2), a ratio of the purified lignin to the block copolymer to the soluble zinc salt to the soluble oxalate to the mixed solvent of ethanol and water is 100 g:5 to 50 g:20 to 100 g:20 to 100 g:2000 to 5000 mL.

More Preferably, in the step (2), the ratio of the purified lignin to the block copolymer to the soluble zinc salt to the soluble oxalate to the mixed solvent of ethanol and water is 100 g:20 to 30 g:50 to 80 g:50 to 80 g:2000 to 3000 mL.

Preferably, in the step (1), the industrial lignin is at least one of wood pulp alkali lignin, bamboo pulp alkali lignin, wheatgrass pulp alkali lignin, bagasse pulp alkali lignin, wood pulp black liquor lignin, bamboo pulp black liquor lignin, wheatgrass pulp black liquor lignin, and bagasse pulp black liquor lignin.

Preferably, in the step (1), the alkali solution with a pH of 12 or more is at least one of ammonia water, sodium hydroxide solution, and potassium hydroxide solution.

Preferably, in the step (1), a mass concentration of the industrial lignin in the alkali solution is 10% to 30%; more Preferably is 10 to 20%.

Preferably, in the step (1), the pH of the solution by adding acid for adjustment is 5 to 7, pH is preferably 6. The acid is at least one of hydrochloric acid, sulfuric acid, and phosphoric acid of 0.5 to 1.5 mol/L.

Preferably, in the step (2), the block copolymer is at least one of polyethylene glycol-b-poly N-isopropyl acrylamide-b-polyacetolactone, star-shaped polylactic acid-polyethylene glycol, methoxypolyethylene glycols-polystyrene-polyacetolactone, polyethylene glycol-aliphatic polyester-polyamino acid and polylactic acid-biotin dextran amine-DTMPDOL, more Preferably polyethylene glycol-b-poly N-isopropyl acrylamide-b-polyacetolactone.

Preferably, in the step (2), a volume ratio of ethanol to water in the mixed solvent of ethanol and water is 1 to 4:1, more Preferably 2 to 3:1.

Preferably, in the step (2), rates for adding dropwise the soluble zinc salt solution and the soluble oxalate solution are 10 to 50 mL/min; the soluble zinc salt is at least one of zinc nitrate, zinc chloride, zinc acetate, and zinc citrate; and the soluble oxalate is at least one of sodium oxalate, potassium oxalate, and ammonium oxalate.

Preferably, in the step (2), a mass concentration of the soluble zinc salt solution and the soluble oxalate solution is 2% to 10%, more Preferably 2% to 6%.

Preferably, in the step (2), the evaporating is carried out by means of vacuum rotary evaporation, and the degree of vacuum is 0.02 to 0.08 MPa, more Preferably 0.04 to 0.06 MPa.

Preferably, in the step (3), the carbonizing is carbonizing at 600 to 900° C. for 1 to 3 h.

Preferably, in the step (3), the carbonizing is performed in an inert gas or nitrogen atmosphere.

Preferably, in the step (3), the washing is washing a carbonized product with 0.1 to 1.5 mol/L of an acid solution for 1 to 3 h, then washing with water.

More Preferably, the 0.1 to 1.5 mol/L of the acid solution is at least one of hydrochloric acid, sulfuric acid, and nitric acid.

Preferably, in the step (3), the drying is at least one of freeze drying, air blast drying, vacuum drying, and IR drying, more Preferably freeze drying.

Preferably, in the step (3), the temperature of drying is 50 to 100° C., and the time of the drying is 2 to 8 h; more Preferably, the temperature of drying is 60 to 80° C. and the time of the drying is for 4 to 6 h.

An accordion-shaped lignin cubic carbon material is prepared by the above-described method.

The above-described accordion-shaped lignin cubic carbon material is applied in a supercapacitor.

The preparation method described in the present invention will be described in more detail below.

(1) dissolving industrial lignin into an alkali solution with a pH of 12 or more, then adding an acid for adjusting the pH of the solution to 5 to 7, filtering to separate a precipitate, and drying the precipitate, to obtain purified lignin;

The purpose of this step by means of an alkali-dissolution and acid-precipitation method is to separate and purify lignin, meanwhile, it is necessary to meet the requirement of good solubility of the ethanol/water mixing system in the step (2) for lignin, so the solution is adjusted to the pH of 5 to 7 by adding the acid.

If pH<5, the solubility of lignin in the ethanol/water system is too large, and in the process of evaporating the solvent in the step (2), it is difficult to co-deposit the mixed micelles of lignin/block copolymer with zinc oxalate, and the agglomeration between the mixed micelles is easy to occur, and a confined growth effect of zinc oxalate on lignin cannot be exerted. If pH>7, the solubility of lignin in the ethanol/water system is too small, the number of the mixed micelle of lignin/block copolymer formed in the ethanol/water system is smaller, which cannot be effectively deposited on the surface of zinc oxalate and between the layers of zinc oxalate, the agglomeration is easy to occur between zinc oxalate sheet layers, and it is not conducive to the formation of a lignin/block copolymer/zinc oxalate complex having a stable structure.

(2) adding a certain amount of the purified lignin of the step (1) and a block copolymer into the ethanol-water mixed system, stirring for 2 to 4 hours and standing still for 3 to 6 hours, sequentially slowly adding dropwise a soluble zinc salt and a soluble oxalate solution, then evaporating at a certain evaporation rate at 70˜90° C. for 4 to 8 hours, then filtering, and drying to obtain a lignin/block copolymer/zinc oxalate complex;

This step is to form uniformly dispersed mixed micelles of lignin/block copolymer, which are further deposited on the surface of zinc oxalate and between the layers of zinc oxalate, and with the help of the confinement effect of zinc oxalate on lignin to form a lignin/block copolymer/zinc oxalate complex with a stable structure. It is conducive to the formation of a structurally continuous and stable cubic carbon material during the subsequent carbonization.

In this step, the rate for adding dropwise the soluble zinc salt and the soluble oxalate must be controlled. If the rate for adding dropwise is too slow, a large number of mixed micelles of lignin/block copolymer will deposit into multilayer micellar spheres on the surface of zinc oxalate, and the interconnected stable structure cannot be formed between the zinc oxalate sheet layers, which cannot exert the confinement effect of zinc oxalate. If the rate for adding dropwise is too fast, zinc oxalate is generated in large quantities in a short period, which causes agglomeration, and the accumulation between the sheet layers is serious, which is not conducive to the subsequent carbonization process. The template zinc oxalate in the system is generated by the reaction of two soluble salts, and cannot be zinc oxalate directly. If zinc oxalate is used directly, mixed micelles of lignin/block copolymer cannot be effectively deposited between the zinc oxalate sheet layers, and at the same time, the agglomeration of zinc oxalate is serious, similarly not conducive to the subsequent carbonization process.

(3) carbonizing the lignin/block copolymer/zinc oxalate complex of the step (2), washing, centrifuging, and drying to obtain an accordion-shaped lignin cubic carbon material.

A carbonizing atmosphere is nitrogen, argon, or other inert gases in this step. The temperature for carbonization is required to be in the range of 600 to 900° C., and the time for carbonization is 1 to 3 h. If the temperature is too low and the time is too short, it will lead to incomplete carbonization. If the temperature is too high and the time is too long, it will not only increase the production costs but also cause the structure of the cubic carbon material to be unstable.

Relative to the prior art, the present invention has the following advantages and effects:

(1) An accordion-shaped lignin cubic carbon material prepared in the present invention has an ordered and interconnected lamellar structure and superior structural stability, which can not only improve the diffusion rate of electrolyte ions but also increase the effective utilization rate of the specific surface area of the carbon material. As an electrode material for supercapacitors, it has excellent mass-specific capacitance and area-specific capacitance as well as rate capability.

(2) In the preparation process of the accordion-like lignin cubic carbon material in the present invention, industrial alkali lignin is used as a carbon source, and a self-assembled zinc oxalate generated through a combination and evaporation of mixed micelles is used as a template, achieving the confined growth of lignin. The obtained carbon material has a nanosheet layer structure and an orderly macrostructure, which has potential application prospects in energy storage materials. In addition, its raw material is abundant in reserves, cheap, and easily available. Its preparation process is simple and environmentally friendly, realizing the high value-added utilization of lignin.

### DESCRIPTION OF DRAWING

FIG. 1 shows a scanning electron microscope photo of an accordion-shaped lignin cubic carbon material prepared in Example 1 of the present invention.

FIG. 2 shows a transmission electron microscope photo (1×2 micron) of the accordion-shaped lignin cubic carbon material prepared in Example 1 of the present invention.

FIG. 3 shows nitrogen adsorption and desorption curves and a pore diameter distribution plot of the accordion-shaped lignin cubic carbon material prepared in Example 1 of the present invention.

FIG. 4 shows a cyclic voltammetry graph of the accordion-shaped lignin cubic carbon material prepared in Example 1 of the present invention.

FIG. 5 shows the constant DC charge and discharge curves of the accordion-shaped lignin cubic carbon material prepared in Example 1 of the present invention.

### DETAILED DESCRIPTION OF EMBODIMENTS

The present invention will be further described below in detail in combination with Examples and drawings, but embodiments of the present invention are not limited thereto.

If the specific conditions are not specified, operations shall be carried out in accordance with the general conditions or the conditions recommended by the manufacturer. The raw materials, reagents, etc. without specified manufacturers are conventional products that are commercially available.

Polyethylene glycol-b-poly N-isopropyl acrylamide-b-polyacetolactone, star-shaped polylactic acid-polyethylene glycol, methoxypolyethylene glycols-polystyrene-polyacetolactone, and polylactic acid-biotin dextran amine-DTMPDOL used in Examples and Comparative Examples are purchased from Sigma Aldrich.

### Example 1

The following steps are performed:
dissolving 200 g of industrial wood pulp alkali lignin into 2000 mL of a sodium hydroxide alkali solution with a pH of 12, then adding 0.5 mol/L of hydrochloric acid for adjusting the solution to a pH of 5, filtering to separate a precipitate, and drying the precipitate at 80° C. in air blast oven for 6 h, to obtain purified lignin;
weighing 10 g of the purified wood pulp alkali lignin and 2 g of polyethylene glycol-b-poly N-isopropyl acrylamide-b-polyacetolactone, adding sequentially into 400 mL of a mixed solvent of ethanol/water (with a volume ratio of 3:1), ultrasonic dispersing for 30 min, and stirring for 2 h, then adding sequentially 100 g of an aqueous solution containing 5 g pure zinc nitrate and 100 g of an aqueous solution containing 5 g pure sodium oxalate, with rates for adding dropwise the solutions controlled to 30 mL/min with a peristaltic pump, stirring for evenly dispersing each of the materials in the system while adding dropwise, after adding dropwise the solutions, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/polyethylene glycol-b-poly N-isopropyl acrylamide-b-polyacetolactone/zinc oxalate complex; and
placing the above-described complex under a nitrogen atmosphere, carbonizing at 800° C. for 2 h to obtain a lignin carbon/zinc oxide complex, and immersing the product in 0.5 mol/L of hydrochloric acid and washing for 1 h, then washing with water, filtering, and freeze drying to obtain a lignin cubic carbon material.

### Example 2

The following steps are performed:
dissolving 200 g of industrial bamboo pulp alkali lignin into 2000 mL of a potassium hydroxide alkali solution with a pH of 12, then adding 1.5 mol/L of hydrochloric acid for adjusting the solution to a pH of 6, filtering to separate a precipitate, and drying the precipitate at 80° C. in IR oven for 6 h, to obtain purified lignin;
weighing 10 g of the purified bamboo pulp alkali lignin and 5 g of polyethylene glycol-b-poly N-isopropyl acrylamide-b-polyacetolactone and adding sequentially into 500 mL of a mixed solvent of ethanol/water (with a volume ratio of 4:1), ultrasonic dispersing for 30 min, and stirring for 3 h, then adding sequentially 100 g of an aqueous solution containing 3 g pure zinc nitrate and 100 g of an aqueous solution containing 3 g pure potassium oxalate, with rates for adding dropwise the solutions controlled to 40 mL/min with a peristaltic pump, stirring for evenly dispersing each of the materials in the system while adding dropwise, after adding dropwise the solutions, rotary evaporating the mixed solution under conditions of 80° C. and a vacuum degree of 0.05 MPa for 4 h, standing still and filtering to obtain a precipitate, and drying the precipitate at 60° C. in IR oven for 5 h to obtain a lignin/polyethylene glycol-b-poly N-isopropyl acrylamide-b-polyacetolactone/zinc oxalate complex; and
placing the above-described complex in an argon atmosphere, carbonizing at 700° C. for 1 h to obtain a lignin carbon/zinc oxide complex, and immersing the product in 1 mol/L of sulfuric acid and washing for 2 h, then washing with water, filtering, and IR drying to obtain a lignin cubic carbon material.

### Example 3

The following steps are performed:
dissolving 200 g of industrial wheatgrass pulp alkali lignin into 2000 mL of an ammonia water alkali solution with a pH of 12, then adding 1.0 mol/L of hydrochloric acid for adjusting the solution to a pH of 7, filtering to separate a precipitate, and drying the precipitate at 80° C. in air blast oven for 6 h, to obtain purified lignin;
weighing 10 g of the purified wheatgrass pulp alkali lignin and 4 g of star-shaped polylactic acid-polyethylene glycol, sequentially adding into 500 mL of a mixed solvent of ethanol/water (with a volume ratio of 2:1), ultrasonic dispersing for 30 min, and stirring for 2 h, then sequentially adding 100 g of an aqueous solution containing 4 g pure zinc acetate and 100 g of an aqueous solution containing 4 g pure ammonium oxalate, with rates for adding dropwise the solutions controlled to 35 mL/min with a peristaltic pump, stirring for evenly dispersing each of the materials in the system while adding dropwise, after adding dropwise the solutions, rotary evaporating the mixed solution under conditions of 70° C. and a vacuum degree of 0.06 MP for 6 h, standing still and filtering to obtain a precipitate, and drying the precipitate at 70° C. in IR oven for 6 h to obtain a lignin/star-shaped polylactic acid-polyethylene glycol/zinc oxalate complex; and
placing the above-described complex under a nitrogen atmosphere, carbonizing at 900° C. for 3 h to obtain a lignin carbon/zinc oxide complex, immersing the product in 0.5 mol/L of nitric acid and washing for 1.5 h, then washing with water, filtering, and vacuum drying to obtain a lignin cubic carbon material.

### Example 4

The following steps are performed:
dissolving 200 g of industrial bagasse pulp alkali lignin into 2000 mL of a sodium hydroxide alkali solution with a pH of 12, then adding 0.5 mol/L of hydrochloric acid for adjusting the solution to a pH of 5, filtering to separate a precipitate, and drying the precipitate at 80° C. in IR oven for 6 h, to obtain purified lignin;
weighing 10 g of the purified bagasse pulp alkali lignin and 10 g of methoxypolyethylene glycols-polystyrene-polyacetolactone, sequentially adding into 400 mL of a mixed solvent of ethanol/water (with a volume ratio of 4:1), ultrasonic dispersing for 30 min, stirring for 3 h, then sequentially adding 100 g of an aqueous solution containing 6 g pure zinc citrate and 100 g of an aqueous solution containing 6 g pure sodium oxalate, with rates for adding dropwise the solutions controlled to 45 mL/min with a peristaltic pump, stirring for evenly dispersing each of the materials in the system while adding dropwise, after adding dropwise the solutions, rotary evaporating the mixed solution under conditions of 75° C. and a vacuum degree of 0.05 MPa for 4 h, standing still and filtering to obtain a precipitate, and drying the precipitate at 80° C. in air blast oven for 4 h to obtain a lignin/methoxypolyethylene glycols-polystyrene-polyacetolactone/zinc oxalate complex; and placing the above-described complex under a nitrogen atmosphere, carbonizing at 600° C. for 2.5 h to obtain a lignin carbon/zinc oxide complex, immersing the product in 1.5 mol/L of hydrochloric acid and washing for 3 h, then washing with water, filtering, and freeze drying to obtain a lignin cubic carbon material.

### Example 5

The following steps are performed:
dissolving 200 g of industrial wheatgrass pulp alkali lignin into 2000 mL of a potassium hydroxide alkali solution with a pH of 12, then adding 0.5 mol/L of sulfuric acid for adjusting the solution to a pH of 6, filtering to separate a precipitate, and drying the precipitate at 80° C. in vacuum oven for 6 h, to obtain purified lignin;
weighing 10 g of the purified wheatgrass pulp alkali lignin and 5 g of polyethylene glycol-b-poly N-isopropyl acrylamide-b-polyacetolactone, sequentially adding into 300 mL of a mixed solvent of ethanol/water (with a volume ratio of 4:1), ultrasonic dispersing for 30 min, and stirring for 2 h, then sequentially adding 100 g of an aqueous solution containing 3 g pure zinc citrate and 100 g of an aqueous solution containing 3 g pure sodium oxalate, with rates for adding dropwise the solutions controlled to 45 mL/min with a peristaltic pump, stirring for evenly dispersing each of the materials in the system while adding dropwise, after adding dropwise the solutions, rotary evaporating the mixed solution under conditions of 85° C. and a vacuum degree of 0.05 MPa for 4 h, standing still and filtering to obtain a precipitate, and drying the precipitate at 80° C. in vacuum oven for 4 h to obtain a lignin/polyethylene glycol-b-poly N-isopropyl acrylamide-b-polyacetolactone/zinc oxalate complex; and
placing the above-described complex in an argon atmosphere, carbonizing at 850° C. for 3 h to obtain a lignin carbon/zinc oxide complex, immersing the product in 0.5 mol/L of hydrochloric acid and washing for 2 h, then washing with water, filtering, and IR drying to obtain a lignin cubic carbon material.

### Example 6

The following steps are performed:
dissolving 200 g of industrial bamboo pulp alkali lignin into 2000 mL of a sodium hydroxide alkali solution with a pH of 12, then adding 0.5 mol/L of phosphoric acid solution for adjusting the solution to a pH of 7, filtering to separate a precipitate, and drying the precipitate at 80° C. in air blast oven for 6 h, to obtain purified lignin;
weighing 10 g of the purified bamboo pulp alkali lignin and 6 g of polylactic acid-biotin dextran amine-DTMPDOL, sequentially adding into 450 mL of a mixed solvent of ethanol/water (with a volume ratio of 3.5:1), ultrasonic dispersing for 30 min, stirring for 2 h, then sequentially adding 100 g of an aqueous solution containing 2 g pure zinc acetate and 100 g of an aqueous solution containing 2 g pure ammonium oxalate, with rates for adding dropwise the solutions controlled to 35 mL/min with a peristaltic pump, stirring for evenly dispersing each of the materials in the system while adding dropwise, after adding dropwise the solutions, rotary evaporating the mixed solution under conditions of 70° C. and a vacuum degree of 0.04 MPa for 6 h, standing still and filtering to obtain a precipitate, and drying the precipitate at 80° C. in air blast oven for 6 h to obtain a lignin/polylactic acid-biotin dextran amine-DTMPDOL/zinc oxalate complex; and
placing the above-described complex under a nitrogen atmosphere, carbonizing at 650° C. for 2 h to obtain a lignin carbon/zinc oxide complex, immersing the product in 1.5 mol/L of sulfuric acid and washing for 3 h, then washing with water, filtering, and freeze drying to obtain a lignin cubic carbon material.

The effect of the Examples is described as follows.

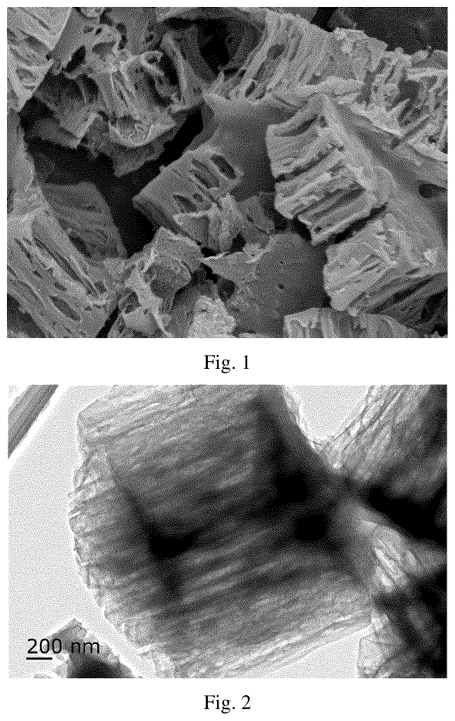

The accordion-like lignin cubic carbon material prepared in Example 1 is applied for an electrode material of a supercapacitor. The material is characterized and electrochemically tested. The results are shown in Table 1 and FIG. 1 to FIG. 5.

The micromorphology and the structure of the samples are characterized by scanning electron microscopy (SEM, Hitachi S-550) and high-resolution field emission transmission electron microscopy (HRTEM, JEOL JEM-2100F, 200 kV). The specific surface area and the pore structure of the samples are tested by an automatic surface area and porosity analyzer (Micromeritics ASAP 2020 instrument).

The electrochemical test is carried out on the electrochemical workstation (CHI660E, Shanghai Chenhua), and a three-electrode system is used in all tests. The preparation process of a working electrode comprises the following steps: dispersing the prepared lignin cubic carbon material, acetylene black, and poly (tetrafluoroethylene) emulsion (with a solid content of 60 wt %) at a mass ratio of 8:1:1 in absolute ethanol, fully grounding, and coating on 1 cm×1 cm nickel foam after the ethanol is completely volatilized, tableting to obtain the working electrode. A platinum sheet electrode is used as a counter electrode, and a saturated calomel electrode is used as a reference electrode. The cyclic voltammetry test is completed at a sweep speed of 5 to 200 mV/s in a voltage window of −1 to 0 V. The constant DC charge-discharge curve test is completed with a current density of 0.5 to 20.0 A/g in a voltage window of −1 to 0 V.

Table 1 is a comparison of the accordion-like lignin cubic carbon materials prepared in the above-described Examples with samples prepared in the following Comparative Examples in terms of electrochemical performances.

The preparation processes for samples of Comparative Examples are as follows.

### Comparative Example 1 (Hydrophobic Assembly being Carried Out)

The processes in patent application CN109485029A and literature (Chemical Engineering Journal 392 (2020) 12372) are carried out.

The following steps are performed:
dissolving 200 g of industrial wood pulp alkali lignin into 2000 mL of a sodium hydroxide alkali solution with a pH of 12, then adding 0.5 mol/L of hydrochloric acid for adjusting the solution to a pH of 5, filtering to separate a precipitate, and drying the precipitate at 80° C. in air blast oven for 6 h, to obtain purified lignin;
weighing 10 g of the purified lignin and 2 g polyethylene glycol-b-poly N-isopropyl acrylamide-b-polyacetolactone, sequentially adding into 100 mL of water, ultrasonic dispersing for 30 min, and stirring for 2 h, then sequentially adding 100 g of a solution containing 5 g pure zinc nitrate and 100 g of an aqueous solution containing 5 g pure sodium oxalate, with rates for adding dropwise the solutions controlled to 30 mL/min with a peristaltic pump, stirring for evenly dispersing each of the materials in the system while adding dropwise, after adding dropwise the solutions, adding dropwise 300 mL ethanol in the mixed system by using the peristaltic pump again with the rate for adding dropwise of 30 mL/min, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/polyethylene glycol-b-poly N-isopropyl acrylamide-b-polyacetolactone/zinc oxalate complex; and
placing the above-described complex under a nitrogen atmosphere, carbonizing at 800° C. for 2 h to obtain a lignin carbon/zinc oxide complex, immersing the product in 0.5 mol/L of hydrochloric acid and washing for 1 h, then washing with water, filtering, and freeze drying to obtain a lignin carbon material.

### Comparative Example 2 (a Water-Soluble Sulfonated Lignin)

A water-soluble sulfonated lignin in patent application CN109485029A and a literature (Chemical Engineering Journal 392 (2020) 12372) is used.

The following steps are performed:
dissolving 200 g of a water-soluble sulfonated lignin into 2000 mL of a sodium hydroxide alkali solution with a pH of 12, then adding 0.5 mol/L of hydrochloric acid for adjusting the solution to a pH of 5, filtering to separate a precipitate, and drying the precipitate at 80° C. in air blast oven for 6 h, to obtain purified lignin;
weighing 10 g of the purified water-soluble sulfonated lignin and 2 g polyethylene glycol-b-poly N-isopropyl acrylamide-b-polyacetolactone, sequentially adding into 400 mL of a mixed solvent of ethanol/water (with a volume ratio of 3:1), ultrasonic dispersing for 30 min, and stirring for 2 h, then sequentially adding 100 g of an aqueous solution containing 5 g pure zinc nitrate and 100 g of an aqueous solution containing 5 g pure sodium oxalate, with rates for adding dropwise the solutions controlled to 30 mL/min with a peristaltic pump, stirring for evenly dispersing each of the materials in the system while adding dropwise, after adding dropwise the solutions, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/polyethylene glycol-b-poly N-isopropyl acrylamide-b-polyacetolactone/zinc oxalate complex; and
placing the above-described complex under a nitrogen atmosphere, carbonizing at 800° C. for 2 h to obtain a lignin carbon/zinc oxide complex, immersing the product in 0.5 mol/L of hydrochloric acid and washing for 1 h, then washing with water, filtering, and freeze drying to obtain a lignin carbon material.

### Comparative Example 3 (Zinc Oxalate being Used Directly)

The following steps are performed:
dissolving 200 g of industrial wood pulp alkali lignin into 2000 mL of a sodium hydroxide alkali solution with a pH of 12, then adding 0.5 mol/L of hydrochloric acid for adjusting the solution to a pH of 5, filtering to separate a precipitate, and drying the precipitate at 80° C. in air blast oven for 6 h, to obtain purified lignin;
weighing 10 g of the purified wood pulp alkali lignin and 2 g polyethylene glycol-b-poly N-isopropyl acrylamide-b-polyacetolactone, sequentially adding into 400 mL of a mixed solvent of ethanol/water (with a volume ratio of 3:1), ultrasonic dispersing for 30 min, and stirring for 2 h, then adding 100 g of an aqueous solution containing 10 g of pure zinc oxalate, with rate for adding dropwise the solution controlled to 30 mL/min with a peristaltic pump, stirring for evenly dispersing each of the materials in the system while adding dropwise, after adding dropwise the solution, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/polyethylene glycol-b-poly N-isopropyl acrylamide-b-polyacetolactone/zinc oxalate complex; and
placing the above-described complex under a nitrogen atmosphere, carbonizing at 800° C. for 2 h to obtain a lignin carbon/zinc oxide complex, immersing the product in 0.5 mol/L of hydrochloric acid and washing for 1 h, then washing with water, filtering, and freeze drying to obtain a lignin carbon material.

### Comparative Example 4 (No Block Copolymer Added)

The following steps are performed:
dissolving 200 g of industrial wood pulp alkali lignin into 2000 mL of a sodium hydroxide alkali solution with a pH of 12, then adding 0.5 mol/L of hydrochloric acid for adjusting the solution to a pH of 5, filtering to separate a precipitate, and drying the precipitate at 80° C. in air blast oven for 6 h, to obtain purified lignin;
weighing 10 g of the purified wood pulp alkali lignin and adding into 400 mL of a mixed solvent of ethanol/water (with a volume ratio of 3:1), ultrasonic dispersing for 30 min, and stirring for 2 h, then sequentially adding 100 g of an aqueous solution containing 5 g pure zinc nitrate and 100 g of an aqueous solution containing 5 g pure sodium oxalate, with rates for adding dropwise the solutions controlled to 30 mL/min with a peristaltic pump, stirring for evenly dispersing each of the materials in the system while adding dropwise, after adding dropwise the solutions, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/zinc oxalate complex; and
placing the above-described complex under a nitrogen atmosphere, carbonizing at 800° C. for 2 h to obtain a lignin carbon/zinc oxide complex, immersing the product in 0.5 mol/L of hydrochloric acid and washing for 1 h, then washing with water, filtering, and freeze drying to obtain a lignin carbon material.

### Comparative Example 5 (Polyoxypropylene Polyoxyethylene Copolymer F127 in the Literature being Used)

The following steps are performed:
dissolving 200 g of industrial wood pulp alkali lignin into 2000 mL of a sodium hydroxide alkali solution with a pH of 12, then adding 0.5 mol/L of hydrochloric acid for adjusting the solution to a pH of 5, filtering to separate a precipitate, and drying the precipitate at 80° C. in air blast oven for 6 h, to obtain purified lignin;
weighing 10 g of the purified wood pulp alkali lignin and 2 g F127, sequentially adding into 400 mL of a mixed solvent of ethanol/water (with a volume ratio of 3:1), ultrasonic dispersing for 30 min, and stirring for 2 h, then sequentially adding 100 g of an aqueous solution containing 5 g pure zinc nitrate and 100 g of an aqueous solution containing 5 g pure sodium oxalate, with rates for adding dropwise the solutions controlled to 30 mL/min with a peristaltic pump, stirring for evenly dispersing each of the materials in the system while adding dropwise, after adding dropwise the solutions, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/polyoxypropylene polyoxyethylene copolymer F127/zinc oxalate complex; and placing the above-described complex under a nitrogen atmosphere, carbonizing at 800° C. for 2 h to obtain a lignin carbon/zinc oxide complex, immersing the product in 0.5 mol/L of hydrochloric acid and washing for 1 h, then washing with water, filtering, and freeze drying to obtain a lignin cubic carbon material.

### Comparative Example 6 (Purified Industrial Wood Pulp Alkali Lignin with pH Less than 5 being Used)

The following steps are performed:
dissolving 200 g of industrial wood pulp alkali lignin into 2000 mL of a sodium hydroxide alkali solution with a pH of 12, then adding 0.5 mol/L of hydrochloric acid for adjusting the solution to a pH of 4, filtering to separate a precipitate, and drying the precipitate at 80° C. in air blast oven for 6 h, to obtain purified lignin;
weighing 10 g of the purified industrial wood pulp alkali lignin and 2 g polyethylene glycol-b-poly N-isopropyl acrylamide-b-polyacetolactone, sequentially adding into 400 mL of a mixed solvent of ethanol/water (with a volume ratio of 3:1), ultrasonic dispersing for 30 min, and stirring for 2 h, then sequentially adding 100 g of an aqueous solution containing 5 g pure zinc nitrate and 100 g of an aqueous solution containing 5 g pure sodium oxalate, with rates for adding dropwise the solutions controlled to 30 mL/min with a peristaltic pump, stirring for evenly dispersing each of the materials in the system while adding dropwise, after adding dropwise the solutions, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/polyethylene glycol-b-poly N-isopropyl acrylamide-b-polyacetolactone/zinc oxalate complex.

### Comparative Example 7 (Purified Industrial Wood Pulp Alkali Lignin with pH Greater than 7 being Used)

The following steps are performed:
dissolving 200 g of industrial wood pulp alkali lignin into 2000 mL of a sodium hydroxide alkali solution with a pH of 12, then adding 0.5 mol/L of hydrochloric acid for adjusting the solution to a pH of 8, filtering to separate a precipitate, and drying the precipitate at 80° C. in air blast oven for 6 h, to obtain purified lignin;
weighing 10 g of the purified industrial wood pulp alkali lignin and 2 g of polyethylene glycol-b-poly N-isopropyl acrylamide-b-polyacetolactone, sequentially adding into 400 mL of a mixed solvent of ethanol/water (with a volume ratio of 3:1), ultrasonic dispersing for 30 min, and stirring for 2 h, then sequentially adding 100 g of an aqueous solution containing 5 g pure zinc nitrate and 100 g of an aqueous solution containing 5 g pure sodium oxalate, with rates for adding dropwise the solutions controlled to 30 mL/min with a peristaltic pump, stirring for evenly dispersing each of the materials in the system while adding dropwise, after adding dropwise the solutions, rotary evaporating the mixed solution under conditions of 70° C. and a vacuum degree of 0.04 MPa for 4 h, standing still and filtering to obtain a precipitate, and drying the precipitate at 80° C. in air blast oven for 4 h to obtain a lignin/polyethylene glycol-b-poly N-isopropyl acrylamide-b-polyacetolactone/zinc oxalate complex; and
placing the above-described complex under a nitrogen atmosphere, carbonizing at 800° C. for 2 h to obtain a lignin carbon/zinc oxide complex, immersing the product in 0.5 mol/L of hydrochloric acid and washing for 1 h, then washing with water, filtering, and freeze drying to obtain a lignin carbon material.

TABLE 1
Structural features and electrochemical performances of the accordion-shaped
lignin cubic carbon materials and materials of Comparative Example 1 to 5

| | characteristic structural parameter of carbon material | | | | mass-specific | | | area-specific | | | |
|---|---|---|---|---|---|---|---|---|---|---|---|
| | specific | | | | capacitance (F/g) at | | | capacitance (μF/cm²) at | | | retention rate |
| | surface | sheet layer | | | different current | | | different current | | | of specific |
| electrode | area | thickness | | sizes | densities (A/g) | | | densities (A/g) | | | capacitance |
| material | (m²/g) | (nm) | morphology | (μm) | 0.5 | 5 | 20 | 0.5 | 5 | 20 | (%) |
| Example 1 | 1050 | <20 | cube | <2 | 358 | 273 | 255 | 34.1 | 26.8 | 24.3 | 71.2 |
| Example 2 | 1003 | <20 | Cube | <2 | 339 | 268 | 240 | 33.8 | 26.7 | 23.9 | 70.8 |
| Example 3 | 1009 | <20 | Cube | <2 | 355 | 280 | 249 | 35.2 | 27.8 | 24.7 | 70.1 |
| Example 4 | 1012 | <20 | Cube | <2 | 340 | 267 | 239 | 33.6 | 26.3 | 23.6 | 70.3 |
| Example 5 | 1024 | <20 | Cube | <2 | 336 | 270 | 239 | 32.8 | 26.4 | 23.3 | 71.0 |
| Example 6 | 1031 | <20 | Cube | <2 | 332 | 255 | 235 | 32.2 | 24.7 | 22.8 | 70.8 |
| Comparative | 1252 | >50 | two-dimensional | >10 | 288 | 190 | 150 | 23.0 | 15.2 | 12.0 | 52.0 |
| example 1 | | | sheet | | | | | | | | |
| Comparative | 1277 | >50 | two-dimensional | >10 | 276 | 177 | 140 | 21.6 | 14.0 | 11.0 | 50.7 |
| Example 2 | | | sheet | | | | | | | | |
| Comparative | 927 | >50 | agglomerated | >10 | 128 | 78 | 64 | 13.8 | 8.4 | 6.9 | 50.0 |
| Example 3 | | | block | | | | | | | | |
| Comparative | 739 | >100 | agglomerated | >10 | 107 | 72 | 53 | 14.5 | 9.7 | 7.2 | 49.5 |
| Example 4 | | | block | | | | | | | | |
| Comparative | 836 | >100 | agglomerated | >10 | 126 | 85 | 60 | 15.1 | 10.2 | 7.2 | 47.4 |
| Example 5 | | | block | | | | | | | | |
| Comparative | 946 | >100 | agglomerated | >10 | 140 | 94 | 65 | 14.8 | 10.7 | 6.9 | 46.4 |
| Example 6 | | | block | | | | | | | | |
| Comparative | 950 | >100 | agglomerated | >10 | 138 | 90 | 58 | 14.5 | 9.5 | 6.1 | 42.0 |
| Example 7 | | | block | | | | | | | | |

Table 1 is explained below.

The mass-specific capacitance and area-specific capacitance of the accordion-shaped lignin cubic carbon material prepared in Example 1 are respectively 358 F/g and 34.1 μF/cm² at a current density of 0.5A/g. When the current density is 20 A/g, the mass-specific capacitance and the area-specific capacitance of the carbon material are respectively 255 F/g and 24.3 μF/cm², and its retention rate of specific capacitance, which is the rate capability of the material, is up to 71.2%.

All samples of Examples have a mass-specific capacitance higher than 330 F/g, an area-specific capacity greater than 34.1 μF/cm², and a rate capability higher than 71.2%, which are much higher than those of samples in Comparative Examples. This is mainly due to the following two points. (1) The orderly interconnected lamellar structure of the lignin cubic carbon material accelerates the ion transport rate, meanwhile improving the effective utilization rate of the specific surface area of this material, and (2) the confinement effect of zinc oxalate on lignin strengthens the structural stability of the cubic carbon material. The synergistic effect of the two makes the lignin cubic carbon material have both high mass-specific capacitance and area-specific capacitance and high rate capability. Therefore, the accordion-like lignin cubic carbon material prepared by the present invention shows very excellent electrochemical performances on its specific capacitance or rate capability.

Whereas, in Table 1, (1) the unsulfonated lignin of the sample in Comparative Example 1 has a lower solubility in aqueous solution, being unable to form sufficient binary mixed micelles with a block copolymer and deposit on the surface of zinc oxalate and between layers of zinc oxalate. Due to the serious agglomeration of zinc oxalate itself, a disordered precipitate is obtained by hydrophobic self-assembly. Although the carbonized product presents a two-dimensional lamellar structure, the macroscopic structure is disordered, the sheet layer is thicker, and the accordion-like cubic structure can be not obtained, whose mass-specific capacitance and area-specific capacitance are respectively 288 F/g and 23.0 μF/cm² with the rate capability of only 52.0%. (2) In the sample in Comparative Example 2, the solubility of the water-soluble sulfonated lignin in the ethanol/water system is lower, and the zinc oxalate sheet layer cannot be effectively dispersed by binary mixed micelles, resulting in disorderly and dispersedly accumulating. The prepared carbon material sheet layer is disordered, and the interconnection between sheet layers cannot be effectively supported, with the mass-specific capacitance and the area-specific capacitance being respectively 276 F/g and 21.6 μF/cm², and the rate capability is only 50.7%. (3) In Comparative Example 3, due to using zinc oxalate directly, the binary mixed micelles of lignin/block copolymer and zinc oxalate are unevenly dispersed, and a large number of micelles are deposited on the surface of zinc oxalate so that the confinement effect of zinc oxalate on lignin cannot be fully exerted. The carbonized material has larger particles, disordered structure, and poor stability, with mass-specific capacitance and area-specific capacitance of only 128 F/g and 13.8 μF/cm² and a retention rate of specific capacitance of 50.0%. (4) In Comparative Example 4, the lignin agglomerates itself to form micelles without adding a block copolymer, which is unevenly dispersed and deposited disorderly on the surface of zinc oxalate and between layers of zinc oxalate. Interconnected lamellar structures cannot be formed during carbonization. Sheets of the carbon material accumulate dispersedly and its structural stability is too poor. Its mass-specific capacitance and area-specific capacitance is 107 F/g and 14.5 μF/cm², with the retention rate of specific capacitance of 49.5%. (5) In Comparative Example 5, the binary mixed micelles formed by the lignin and polyoxypropylene polyoxyethylene copolymer F127 have a wide particle diameter distribution and are easy to agglomerate with each other, which cannot be evenly deposited on the surface of zinc oxalate and between layers of zinc oxalate, resulting in dispersed accumulating of zinc oxalate sheet layers and greatly reducing the structural stability of the carbon material. The specific surface area is 836 m²/g, and the mass-specific capacitance and the area-specific capacitance are only 126 F/g and 15.1 μF/cm². (6) In Comparative Example 6, the solubility of the purified lignin in the ethanol/water system at a pH of 4 is too high, and aggregation between lignin/block copolymer binary mixed micelles is prone to occur. In Comparative Example 7, the solubility of the purified lignin in the ethanol/water system at a pH of 8 is too small, and accumulating between zinc oxalate sheet layers is prone to occur. In either case, it is difficult for micelles to co-deposit with zinc oxalate, and the confined growth effect of zinc oxalate on lignin cannot be exerted. Finally, the prepared lignin carbon material presents a large block shape. The mass-specific capacitance and the area-specific capacitance of the material in Comparative Example 6 are only 140 F/g and 14.8 μF/cm². The mass-specific capacitance and the area-specific capacitance of the material in Comparative Example 7 are only 138 F/g and 14.5 μF/cm².

If a pH<5, the solubility of the lignin in the ethanol/water system is too high. During the process of evaporating the solvent in step (2), it is difficult for the mixed micelles of lignin/block copolymer to co-deposit with zinc oxalate, and aggregation is prone to occur between the mixed micelles so that the confined growth effect of zinc oxalate on lignin cannot be exerted. If the pH>7, the solubility of the lignin in the ethanol/water system is too small, and the number of mixed micelles of lignin/block copolymer formed in the ethanol/water system is relatively small, which cannot effectively deposit on the surface of zinc oxalate and between layers of zinc oxalate. Agglomeration between zinc oxalate sheet layers is prone to occur, which is not conducive to the formation of a lignin/block copolymer/zinc oxalate complex with a stable structure.

FIG. 1 is a scanning electron micrograph of the accordion-shaped lignin cubic carbon material prepared in Example 1 of the present invention. It can be seen from the figure that the prepared lignin cubic carbon material has a typical accordion-shaped cubic structure, and orderly interconnection of sheet layers, with good structural stability.

FIG. 2 is a transmission electron micrograph of the accordion-shaped lignin cubic carbon material prepared in Example 1 of the present invention. It can be seen from the figure that the sheet layers of the lignin cubic carbon material interconnect orderly, and there are abundant pore structures between the sheets, which greatly improves the effective utilization rate of the specific surface area of the carbon cubic material.

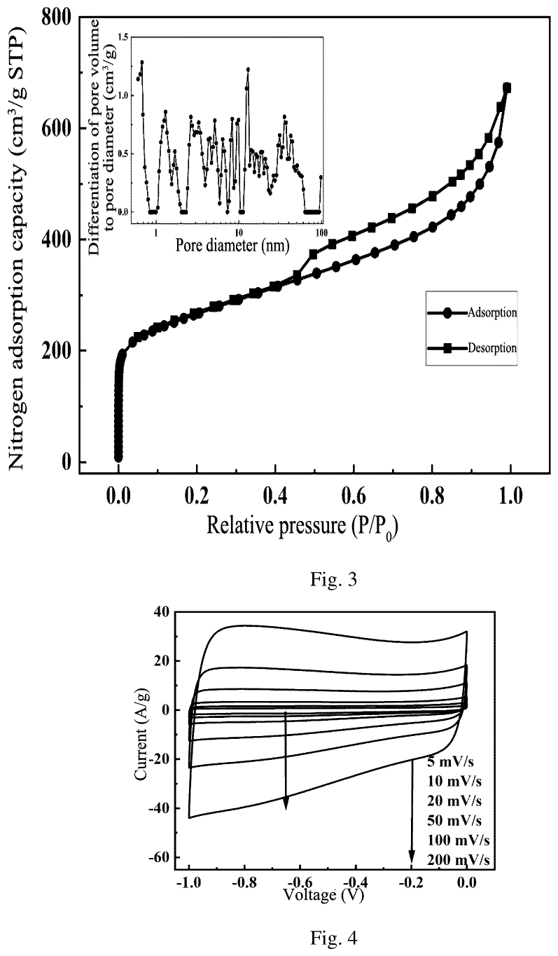

FIG. 3 is the nitrogen adsorption and desorption curves and a pore diameter distribution plot of the accordion-shaped lignin cubic carbon material prepared in Example 1 of the invention. It can be seen from the figure that the adsorption and desorption curves of the lignin cubic carbon material belong to type IV and have H3 hysteresis loops. In areas with lower relative pressure, the nitrogen adsorption capacity rapidly increases, indicating that the material has a microporous structure, while the hysteresis loop appearing in areas with higher relative pressure indicates that the material has a mesoporous structure. The total BET-specific surface area of the lignin porous carbon nanosheets is 1050 m²/g, with a microporous specific surface area of 647 m²/g, a mesoporous specific surface area of 403 m²/g, and a total pore volume of 0.918 cm³/g. It has an extremely wide pore diameter distribution, and reasonable pore structure and rich pore diameter distribution are beneficial for improving electrochemical performances.

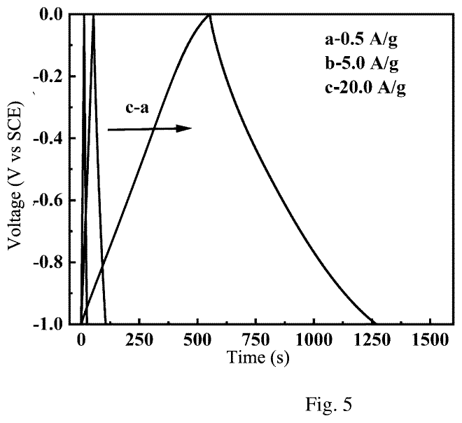

FIG. 4 is a cyclic voltammetry graph of the accordion-shaped lignin cubic carbon material prepared in Example 1 in the present invention. It can be seen from the figure that the curves of the material at different scanning speeds are all in a quasi-rectangle shape, indicating that the material has an ideal double electric layer capacitance. Even at the highest scanning speed, the curve shape remains almost unchanged, which indicates that the material has excellent rate capability.

FIG. 5 is a constant DC charge and discharge curve graph of the accordion-shaped lignin cubic carbon material prepared in Example 1 in the present invention. It can be seen from the figure that the curve shapes of the prepared lignin cubic carbon material are similar to an isosceles triangle under different current densities, which indicates that the carbon material has a typical double electric layer capacitance characteristic.

The above-described Examples are the preferred embodiments of the present invention, but the embodiments of the present invention are not limited by the above-described Examples. Any other changes, modifications, substitutions, combinations, and simplifications made without deviating from the spiritual essence and principles of the present invention should be equivalent replacement modes and be included in the protection scope of the present invention.

1. A preparation method for an accordion-shaped lignin cubic carbon material, characterized in that, it comprises the following steps:
(1) dissolving industrial lignin into an alkali solution with a pH of 12 or more, then adding an acid for adjusting the pH of the solution to 5 to 7, filtering to separate a precipitate, and drying the precipitate, to obtain purified lignin;
(2) adding the purified lignin and a block copolymer into a mixed solvent of ethanol and water, stirring for 2 to 4 h, standing still for 3 to 6 h, forming a mixed micelle of the lignin/the block copolymer, then sequentially adding dropwise a soluble zinc salt solution and a soluble oxalate solution, evaporating at 70 to 90° C. for 4 to 8 h, filtering, and drying, to obtain a lignin/block copolymer/zinc oxalate complex; and
(3) carbonizing the lignin/block copolymer/zinc oxalate complex, washing, centrifuging, and drying, to obtain the accordion-shaped lignin cubic carbon material;
in the step (2), a ratio of the purified lignin to the block copolymer to the soluble zinc salt to the soluble oxalate to the mixed solvent of ethanol and water is 100 g:5 to 50 g:20 to 100 g:20 to 100 g:2000 to 5000 mL.

2. The preparation method for the accordion-shaped lignin cubic carbon material according to claim 1, characterized in that, in the step (2), the block copolymer is at least one of polyethylene glycol-b-poly N-isopropyl acrylamide-b-polyacetolactone, star-shaped polylactic acid-polyethylene glycol, methoxypolyethylene glycols-polystyrene-polyacetolactone, polyethylene glycol-aliphatic polyester-polyamino acid and polylactic acid-biotin dextran amine-DTMPDOL.

3. The preparation method for the accordion-shaped lignin cubic carbon material according to claim 1, characterized in that, in the step (2), a volume ratio of ethanol to water in the mixed solvent is 1 to 4:1.

4. The preparation method for the accordion-shaped lignin cubic carbon material according to claim 1, characterized in that, in the step (2), the ratio of the purified lignin to the block copolymer to the soluble zinc salt to the soluble oxalate to the mixed solvent of ethanol and water is 100 g:20 to 30 g:50 to 80 g:50 to 80 g:2000 to 3000 mL.

5. The preparation method for the accordion-shaped lignin cubic carbon material according to claim 1, characterized in that, in the step (2), rates for adding dropwise the soluble zinc salt solution and the soluble oxalate solution are both 10 to 50 mL/min; mass concentrations of the soluble zinc salt solution and the soluble oxalate solution are both 2% to 10%; the soluble zinc salt is at least one of zinc nitrate, zinc chloride, zinc acetate, and zinc citrate; and the soluble oxalate is at least one of sodium oxalate, potassium oxalate, and ammonium oxalate.

6. The preparation method for the accordion-shaped lignin cubic carbon material according to claim 1, characterized in that, in the step (2), the evaporating is carried out by means of vacuum rotary evaporation, and a degree of vacuum is 0.02 to 0.08 MPa.

7. The preparation method for the accordion-shaped lignin cubic carbon material according to claim 1, characterized in that, in the step (3), the carbonizing means carbonizing at 600 to 900° C. for 1 to 3 h; and the carbonization is performed in an inert gas or nitrogen atmosphere.

8. The preparation method for the accordion-shaped lignin cubic carbon material according to claim 1, characterized in that, in the step (1), the alkali solution with pH of 12 or more is at least one of ammonia water, sodium hydroxide solution, and potassium hydroxide solution; a mass concentration of the industrial lignin in the alkali solution is 10% to 30%; and the acid is at least one of hydrochloric acid, sulfuric acid and phosphoric acid of 0.5 to 1.5 mol/L;
in the step (1), the industrial lignin is at least one selected from the group consisting of wood pulp alkali lignin, bamboo pulp alkali lignin, wheatgrass pulp alkali lignin, bagasse pulp alkali lignin, wood pulp black liquor lignin, bamboo pulp black liquor lignin, wheatgrass pulp black liquor lignin, and bagasse pulp black liquor lignin; and
in the step (3), the washing means washing a carbonized product with 0.1 to 1.5 mol/L of an acid solution for 1 to 3 h and then washing with water.

9. An accordion-shaped lignin cubic carbon material prepared according to the preparation method of claim 1.

10. An application of the accordion-shaped lignin cubic carbon material according to claim 9 in a supercapacitor.
